(19) United States
(12) Patent Application Publication
(10) Pub. No.: US 2006/0119188 A1
(43) Pub. Date: Jun. 8, 2006

(54) Drive device for mining machines

(76) Inventors: Thomas Uvermann, Bergkamen (DE); Arno Breimhorst, Hagen (DE); Werner Dehmel, Lunen (DE); Werner Langenberg, Werne (DE); William Bush, Kings Mountain, NC (US); John Kowaleski, Simpsonville, SC (US); Michael Klein, Kempen (DE); Steve Jones, Cherryville, NC (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/231,417

(22) Filed: Sep. 21, 2005

(30) Foreign Application Priority Data
Sep. 23, 2004 (DE) 202004015038.7

(51) Int. Cl. H02N 3/00

(52) U.S. Cl. 310/10

(57) ABSTRACT

A drive device for mining machines, especially for chain-hauled longwall operating equipment, comprising a drive motor (1) disposed in a motor housing (2) and with a flange (3) for connecting the drive motor (1) to a gear unit (30), at least one measurement-collecting device for detecting operating states of the drive motor (1) and/or of the gear unit (30) and a drive computer for actuating the drive motor (1) and/or for actuating components of the gear unit (30), in which at least one receiving casing (8) for the measurement-collecting device and/or the drive computer is disposed on the outside of the motor housing (2).

The present invention relates to drive devices for mining machines, especially for chain-hauled longwall operating equipment, comprising a drive motor disposed in a motor housing with a flange for connecting the drive motor to a gear unit, at least one measurement-collecting device for detecting operating states of the drive motor and/or of the gear unit, and a drive computer for actuating the drive motor and/or for actuating components of the gear unit.

Mining machines, especially longwall operating equipment such as conveyors and cutters comprising traction chains, contain drive units comprising high-performance electric motors and large gear units flange-mounted on them. The large gear units and the associated clutches, if any, are used for introducing the high drive power of the motors into the drive shafts of the chain wheels of the driven machines. In underground mining, especially good results have been obtained by the modular CST drive system offered for sale by the Assignees, wherein the actual gear stage, usually a planetary gear or bevel gear with an incorporated clutch for starting the machine, is disposed in a first casing part and wherein the supply units such as the cooling-oil pump, high-pressure pump, heat exchanger, hydraulic control, filter and so on, are disposed in a second casing part forming the supply unit. In the original CST gear units, the operating states of the individual gear components detected by sensors were supplied to an electronic measurement-collecting device (data-collecting device) for pre-processing the measurements and likewise incorporated in the casing part of the supply unit. By incorporating the measurement-collecting device in the casing part of the gear unit, short control loops could be obtained for some controlled variables, resulting in a quick response of the corresponding control loops.

DE 201 10 788 U1 discloses a drive device in accordance with the preamble wherein the measurement-collecting device is disposed not in the second gear casing part but in an external receiving casing mounted on the gear unit, in order to reduce the mechanical load on the measurement-collecting device and withdraw it from the immediate range of influence of the fluctuating operating temperatures of the gear unit inside the gear casing. However, the measurements obtained by the measurement-collecting device are still supplied to a drive computer disposed in the longwall or in the transition from the longwall to the road, where the sensor values obtained by the measurement-collecting device are additionally processed and converted into control commands in accordance with algorithms stored in the software of the drive computer.

Owing to the modular structure, with two casing parts in series, the drive device in accordance with the preamble is relatively bulky. It has also been found that if the measurement-collecting device is disposed on the gear casing, especially near the filter, the measurements may still be distorted by fluctuations in temperature.

It is an aim of the present invention to construct a drive device for underground mining which is less bulky than the drive devices in accordance with the preamble, so that the electronics for the measurement detection are disposed in an advantageous region as regards temperature fluctuations and short cables can be used for connecting the sensors to the measurement-collecting device.

Accordingly the present invention, is directed to a drive device for mining machines as described in the opening paragraph of the present specification, wherein at least one receiving casing for the measurement-collecting device and/or the drive computer is disposed on the outside of the motor housing.

Preferably, at least one receiving casing in which at least the measurement-collecting device is disposed is provided on the outside of the motor housing. Since the motor housing is usually smaller in diameter or in height than the downstream gear casing, other receiving casings can be disposed in space-saving manner on the machine housing without altering the total necessary height of the drive device.

Advantageously the receiving casings are so disposed on the motor housing that they are not bulkier than the casing of the downstream gear unit.

In a preferred embodiment, the measurement-collecting device and the drive computer are incorporated in a single computer unit received in one of the receiving casings. Advantageously in that case, a display unit installed in the longwall during operation of the drive device is connected to the computer unit. This enables the measured data to be processed and the drive device to be actuated via extremely short lines, reducing the fault-proneness and the distortion of measurements, and also the operating state of the drive device can be monitored in the longwall at a suitable place, for example inside a shield-type support.

Advantageously a number of separate receiving casings are disposed on the outer wall of the motor housing. The drive computer and the measurement-sampling device or the computer unit, together with other peripherals or electronic parts of the drive or gear unit, voltage supply equipment, active-power signal transducers, for example voltage (transformer)s, current (transformer)s or the like, can then be disposed in various receiving casings.

More especially, the motor housing can have a cylindrical outer wall portion and the receiving casings can have side wall parts with cylindrically curved inner front edges. The back walls of the receiving casings can then be formed either by the outer wall portion of the motor housing or by a back-wall plate adapted to the curvature of the outer-wall portion.

Advantageously the side wall parts have outer front edges comprising at least two straight regions at an angle to one another, so that the receiving casing has a polygonal outer surface. This enables each receiving casing to be closed by at least two flat, separately detachable covers.

In an advantageous embodiment, two receiving casings are disposed on opposite side flanks of the motor housing, wherein preferably a space for laying of supply and/or connecting cables is provided between the two receiving casings. If the receiving casings are disposed on opposite side flanks, the result is an advantageous three-dimensional arrangement. The space also ensures secure, protected laying of the supply cables or connecting cables. Of course, the electric components in the individual receiving casings can be disposed so that the wiring lengths are short and practically no wiring extends outside the receiving casings. More especially, the space between the two receiving-casing compartments can be covered by a detachable closure plate.

In an advantageous embodiment, a frequency-converter (transformer) casing for receiving an electronic frequency converter (transformer) can be disposed on the outside of the motor housing between the receiving casings and the motor flange.

Advantageously, the frequency-converter casing is disposed transversely of the motor casing and on the top thereof. In the prior art, the frequency-converter casings have hitherto been disposed parallel with the engine housing. Now, however, the frequency-converter casing can alternatively be disposed transversely as a result of the receiving casing, which substantially adapts the width of the motor to the width of the gear unit.

An example of a drive device for mining machines in accordance with the present invention will now be explained with reference to the accompanying drawings, in which:

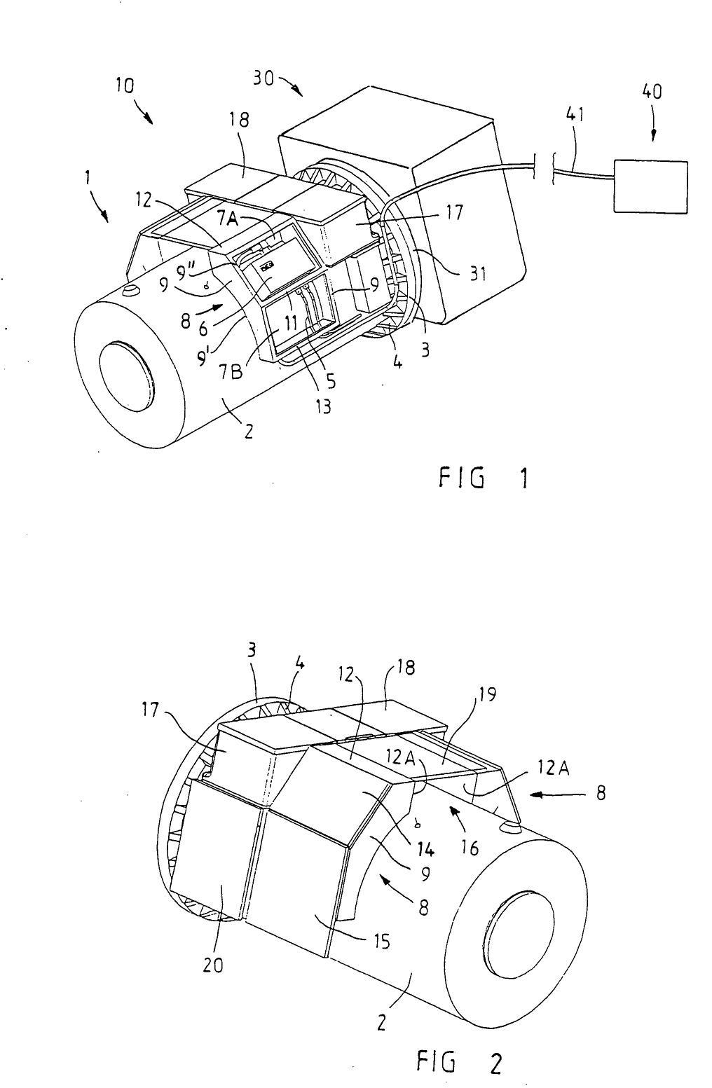

FIG. 1 shows a perspective view of a drive device accordance with the present invention, comprising a driving motor connected to a diagrammatically indicated gear unit, and

FIG. 2 shows a perspective view of the motor housing and the additional receiving casings.

In FIG. 1 a drive device 10 for an underground mining machine such as a longwall conveyor, comprises a high-power electric driving motor 1 with a cylindrical housing 2 torque-braced by a flange 3 against a flange 31 on a schematically indicated gear unit 30. The illustrated part of the gear unit 30 can especially be the supply units, such as the cooling-oil pump, the high-pressure pump for the hydraulic supply, filters or heat exchangers for discharging the heat from the casing part holding the gear unit, which will then adjoin an additional modular casing part containing the actual gear stage, such as a planetary gear and an associated multiple-disc clutch for gently starting the motor.

The motor-connecting flange 3 is fastened by a number of peripherally distributed reinforcing ribs 4 to the cylindrical part of the motor housing 2, which motor housing 2 also contains the electric high-power drive (not shown), such as an adjustable three-phase frequency-converting motor. The drive motor in the casing 2 and the supply units and components of the gear unit 30 are both associated with sensors (not shown) such as pressure sensors, temperature sensors, power-consumption sensors and sensors for detecting the operating state, and also actuators such as valves or the like, connected for example by the electric cable 5 to a computer unit 6 which serves both as a measurement collector for acquiring and processing the measurements detected by the sensor and as a drive computer for actuating the units, actuators and components of the motor 1 and the gear unit 30. The drive computer 6 is received and protected in an upper compartment 7A of a receiving casing 8 mounted on the outer wall of the motor housing 2. The casing 8 extends over part of the lateral portion of the motor housing 2 and comprises front and rear side-wall parts 9, the inner front edges 9′ of which are adapted to the cylindrical curvature of the outer wall of the motor housing 2 and the outer front edges 9″ of which have two respective flat portions at an angle to one another in this case, wherein the first portion is associated with the receiving chamber 7B and the second portion is associated with the receiving chamber 7A. An intermediate wall 11 is disposed between the two receiving chambers 7A, 7B of the casing 8, and upper and lower wall parts 12, 13 close the casing 8 at top and bottom.

As clearly shown in FIG. 2, separate detachable covers 14 and 15 are provided for closing the two chambers of the casing 8. The cover 14 associated with the upper chamber of the casing 8 is flush with the top wall part 12 when closed, whereas the bottom cover 15 extends sideways and parallel with the motor housing 2 down to its lower apex. The two covers 14, 15 abut one another at the level of the intermediate wall (11, FIG. 1). The cover 15 is vertical whereas the cover 14 slopes.

As also clearly shown in FIGS. 1 and 2, an identical but mirror-inverted receiving casing 8 is disposed on each side of the motor housing 2, so that numerous peripherals and units can be disposed in the casings 8. Since other units and peripherals can be disposed in the receiving compartments of the two receiving casings, the gear-unit casing part for the supply unit, for example, can be formed shorter. The two receiving casings 8 on the top apex of the cylindrical motor housing 2 are separated from one another by a few centimetres and the back-wall plates 12A of the top wall parts 12 enclose a space 16 between them for laying a flexible connecting cable (not shown) with electric or hydraulic lines to the drive device 10.

The two receiving casings 8 on the motor housing 2 are disposed at a distance from the motor flange 3, and a rectangular frequency-converter (transformer) casing 17 is disposed between the casings 8 and the flange 3 and extends transversely of the longitudinal dimension of the cylindrical part of the housing 2. The box-like frequency-converter casing 17 is mounted on the top of the motor housing 2 and closed at the top by a number of covers 18. The space 16 is also closed at the top by a detachable plate 19.

As shown especially in FIG. 1, the receiving casing 8 and the frequency-converter casing 17 together with the lateral covers 15 and closure plates 20, shown in FIG. 2 only, have substantially the same dimensions as the gear unit 30 disposed for drive purposes downstream of the driving motor 1. The receiving casings 8 and the frequency-converter casing 17, in the form of superstructures on the engine housing 2, therefore make advantageous use of the space in the underground longwall required for the gear unit 30 and the motor 1, and no additional peripherals or units need to be positioned in other switchgear cabinets or the like.

Finally as shown in FIG. 1, the drive computer 6, disposed and protected in one of the receiving chambers 7A, can be associated with a display computer 40 which is connected by an electric cable 41 to the computer unit 6 and can be disposed in a protected region in the longwall, for example on a shield-type support near the drive, in order also to monitor the operating state of the motor 1 and the gear unit 30 in the longwall.

Of course the individual receiving chambers in the casings 8 are sealed off from all external influences when the covers 14 and 15 are fitted, and the cables are led out of the casings 8 through correspondingly sealed cable bushes. The display unit can also be connected via a cable which, together with the other connecting and supply cables, is connected to a plug connection in the space between the two receiving casings.

1. A drive device for mining machines, especially for chain-hauled longwall operating equipment, comprising a drive motor disposed in a motor housing and with a flange for connecting the drive motor to a gear unit, at least one measurement-collecting device for detecting operating states of the drive motor and/or of the gear unit and a drive computer for actuating the drive motor and/or for actuating components of the gear unit, in which at least one receiving casing for the measurement-collecting device and/or the drive computer is disposed on the outside of the motor housing.

2. A drive device according to claim 1, in which in the measurement-collecting device and the drive computer are incorporated in a computer unit received in the receiving casing.

3. A drive device according to claim 2, in which a display unit, installed in the longwall during operation, is connected to the computer unit.

4. A drive device according to claim 1, in which a number of preferably separate receiving casings are disposed on the outer wall of the motor housing.

5. A drive device according to claim 1, in which the motor housing has a cylindrical outer wall portion and the receiving casings have side-wall parts with cylindrically curved inner front edges.

6. A drive device according to claim 5, in which the side wall parts have repeatedly bent outer front edges.

7. A drive device according to claim 4, in which each receiving casing comprises at least two receiving boxes or compartments and is closed by at least two flat, separately detachable covers.

8. A drive device according to claim 4, in which two receiving casings are disposed on opposite side flanks of the motor housing, wherein a space for laying supply and/or connecting cables is provided between the two receiving casings.

9. A drive device according to claim 8, in which the space is covered by a detachable closure plate.

10. A drive device according to claim 1, in which a frequency converter casing for receiving an electronic frequency converter is disposed on the outside of the motor housing between the receiving casings and the motor flange.

11. A drive device according to claim 10, in which the frequency converter casing is disposed transversely of the motor housing and on the top thereof.

12. A drive device according to claim 1, in which peripherals and monitoring equipment such as signal converters, voltage transformers and/or current transformers are disposed in the receiving chambers.
